(19) United States
(12) Patent Application Publication
(10) Pub. No.: US 2007/0269771 A1
(43) Pub. Date: Nov. 22, 2007

(54) Vehicle simulator with multiple degrees of freedom of motion

(76) Inventor: Norman Lefton, Los Angeles, CA (US)

Correspondence Address: CHRISTIE, PARKER & HALE, LLP, PO BOX 7068, PASADENA, CA, 91109-7068, US

(21) Appl. No.: 11/438,804

(22) Filed: May 22, 2006

(51) Int. Cl. G09B 9/02

(52) U.S. Cl. 434/29

(57) ABSTRACT

The invention is a vehicle simulator. The vehicle simulator has a vehicle simulator operator environment, a vehicle simulator base, a boom connecting the vehicle simulator operator environment to the vehicle simulator base and at least one articulating mechanism. The at least one articulating mechanism is for rotating the vehicle simulator operator environment along at least one axis of rotational motion to provide for a tilting motion of the vehicle simulator operator environment along a Z-axis of rotation. There is also an articulating mechanism for moving the vehicle simulator operator environment along at least an X-axis of rotational motion along the boom and a Y-axis of translational motion with the boom relative to the vehicle simulator base.

### BACKGROUND

Vehicle Motion Simulators have been available for many decades and are used for a variety of purposes including the training of operators of military and commercial motor vehicles, heavy machinery and aircraft. For example, there are a variety of flight simulators for helicopters, jets and propeller aircraft, as well as driver training simulators for trucks, boats, tanks and trains, gunnery training simulators for tanks, wheeled vehicles and boats, mission training simulators for rescue crew and drivers, and industrial simulators and material handling equipment training simulators. In addition to these uses, simulators are used in the entertainment field for a variety of amusement arcade and park rides.

In amusement arcades, motocross and race car types of rides are popular since they allow people to interact to a limited degree with a simulated “motorcycle” and a simulated “race car” while viewing an image of the user's vehicle navigating a selected course. In the case of motorcycle-style arcade rides, the user will turn the handles and lean the simulated motorcycle while being seated to establish movement of the motorcycle and affect the displayed image of the “motorcycle” on the course. Other than this movement of the “vehicle” initiated by the rider, the motorcycle that the user rides does not move in response to the image of a motorcycle moving on the screen. For example, when a rider is supposed to be going over jumps, hills, and dips, and is navigating turns of a motocross course as shown on the display, the simulated motorcycle that the rider is sitting on will not move up and down or side to side, and thus will not provide a realistic riding experience. Likewise, in the case of race car rides, the car the driver sits in does not move (e.g., no banking around turns or tilting up and down when going up and down hills) in response to the driver's input. If the rider's environment (e.g., straddling a motorcycle or sitting inside of a race car) were to actually move in response to the driver's movement, these arcade types of rides would become much more interesting. Indeed, providing a moving operator environment would open the door to many more interesting arcade rides, such as the experience of flying a jet aircraft or an assault helicopter, driving an armored vehicle or tank on rough terrain, riding a motorcycle or snowmobile and becoming airborne, or careening around a tight curve of a racetrack in a formula one race car.

Regardless of their applications, most simulators rely on a motion base to create the various motions that are typically responsive to operator input, which translates these inputs into various motions, including tilting, shaking, thrusting, etc. A common type of motion base includes a floor mounted base unit, a floating platform, and a number of hydraulic or electric cylinders connecting the base to the floating platform. By adjusting the motions of the plurality of cylinders, different degrees of motion can be achieved. For example, Moog Inc. of East Aurora, N.Y., manufactures a variety of motion bases which utilize six hydraulic or electric cylinders arranged in V formations. Due to the complicated nature of the various motions required of the cylinders to achieve a desired effect, a considerable degree of programming with tight tolerances is required for effective operation. Moreover, these types of motion bases are typically very heavy, and must be mounted to a very secure foundation, such as a six-foot thick reinforced concrete base due to the shaking forces created by the motion base. These motion bases can be quite costly to manufacture, install and maintain, and are therefore not feasible for use in most arcade environments. The simulator environment (such as a simulated cockpit of an aircraft or other motor vehicle) will be mounted on top of the motion base. Typically, it is difficult to swap between the use of a simulator for one purpose (e.g., helicopter simulator) with another purpose (e.g., tank simulator), since it requires a substantial amount of reprogramming and customization. For this reason, vehicle simulators are generally set up to represent one type of vehicle. There accordingly remains a need for lower cost simulators that are easier and less expensive to use and operate and also more versatile for a variety of applications, including in amusement arcades.

### BRIEF DESCRIPTION

The invention comprises a simple and low cost vehicle simulator and vehicle operator environment which provides for several degrees of freedom of motion, which may be portable, and which provides for adaptability to various simulator environments, e.g., helicopters, fixed wing aircraft, tanks, trucks, race cars, motorcycles, snowmobiles, etc., without requiring complex reprogramming or replacement of the entire operator environment. These degrees of freedom of motion can include rotational motion of the operator environment around the x axis and the Z axis, and also optionally along the Y axis, plus translational motion of the vehicle operator environment along the y axis, and optionally also along one or both of the X axis and the Z axis, to provide for most, if not all, of the important range of motions that would be desired for an arcade style vehicle simulator or other small format and low cost simulator, which are not provided with present day vehicle simulators based on a motion base consisting of a plurality of cylinders connected between the base and a floating platform, or otherwise.

The vehicle simulator of the invention can move in three to six degrees of freedom based on a relatively simple design that uses groups of cylinders and/or motors to move the operator environment along axes of rotation and longitudinal motion, and can thus obviate the need for complex mechanical structure and difficult to program software. These degrees of freedom of motion can include rotational motion of the operator environment around the X axis, Z axis and optionally the Y axis, plus translational motion of the vehicle operator environment along the Y axis, and optionally also along the Z axis and the X axis. The number of rotational and translations motions can be selected based on cost considerations and the requirements of the vehicle to be simulated.

### BRIEF DESCRIPTION OF THE DRAWINGS

FIG. 1 is a diagrammatic perspective view of a prior art motion base for a vehicle simulator.

FIG. 2 is a diagrammatic front right isometric view showing an exemplary simulator of the invention with multiple degrees of freedom of motion.

FIG. 3 is a diagrammatic front right isometric view showing another embodiment of an exemplary simulator of the invention.

FIG. 4 is a diagrammatic isometric view of an embodiment of a vehicle operator environment with swappable controls.

### DETAILED DESCRIPTION OF THE INVENTION

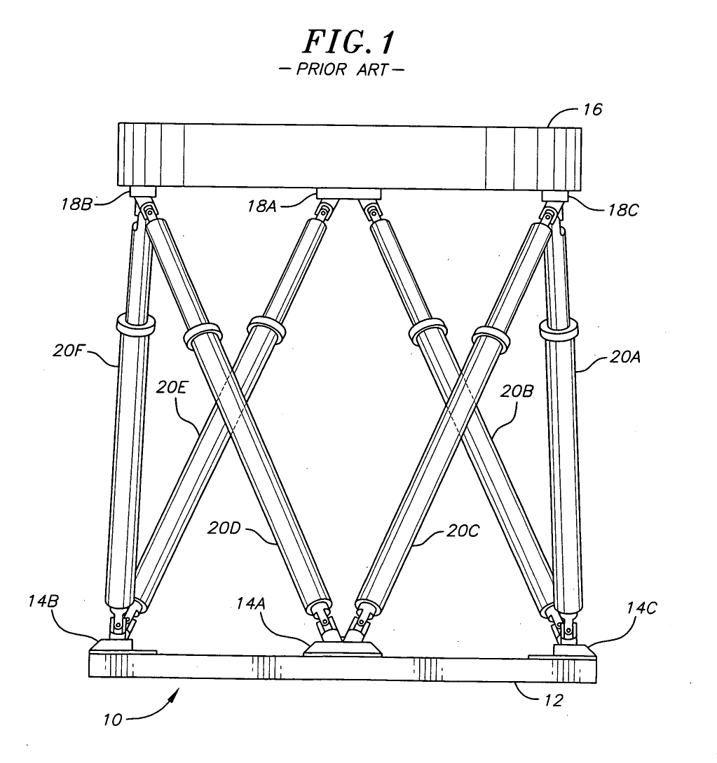

Referring to FIG. 1, there is shown a prior art motion base 10, which has a base portion 12 with three lower anchors, 14a, 14b and 14c, a floating platform portion 16 with upper anchors 18a, 18b and 18c. Six hydraulic or electric cylinders 20a through 20f are connected between the lower anchors 14a, 14b and 14c to the upper anchors 18a, 18b and 18c of the floating platform 16. Cylinder 20a connects at its bottom via a universal joint to anchor 14c and at its top to the anchor 18c, also with a universal joint or other pivot. Cylinder 20b connects at its bottom portion to anchor 14c and at its top to anchor 18a by a universal joint or other pivot. The other cylinders are similarly connected. Cylinder 20c connects at its bottom portion to anchor 14a and at its top to anchor 18c. Cylinder 20d connects at its bottom portion to anchor 14a and to its top to anchor 18b. Cylinder 20e connects at its bottom portion to anchor 14b and connects to anchor 18a at its top. Lastly, cylinder 20f connects at its bottom to corner 14b and at anchor position 18b at its top. Thus, by manipulating the position, thrusts, speeds, etc. of cylinders 20a through 20f, the floating platform 16 can be moved as desired. Not shown, a cockpit or cabin will be mounted to the floating platform 16 where an operator and/or passengers will be situated during motion. Motion of the floating base 16 relative to the stationary base 12 requires extremely precise movement of all the cylinders relative to each other; otherwise, the cylinders will actually work against each other and can cause premature wear and breakage. Of course, while the prior art motion bases can establish six degrees of freedom of motion, these designs restrict the extent of the motion, e.g. full rolls and spins cannot be fully replicated.

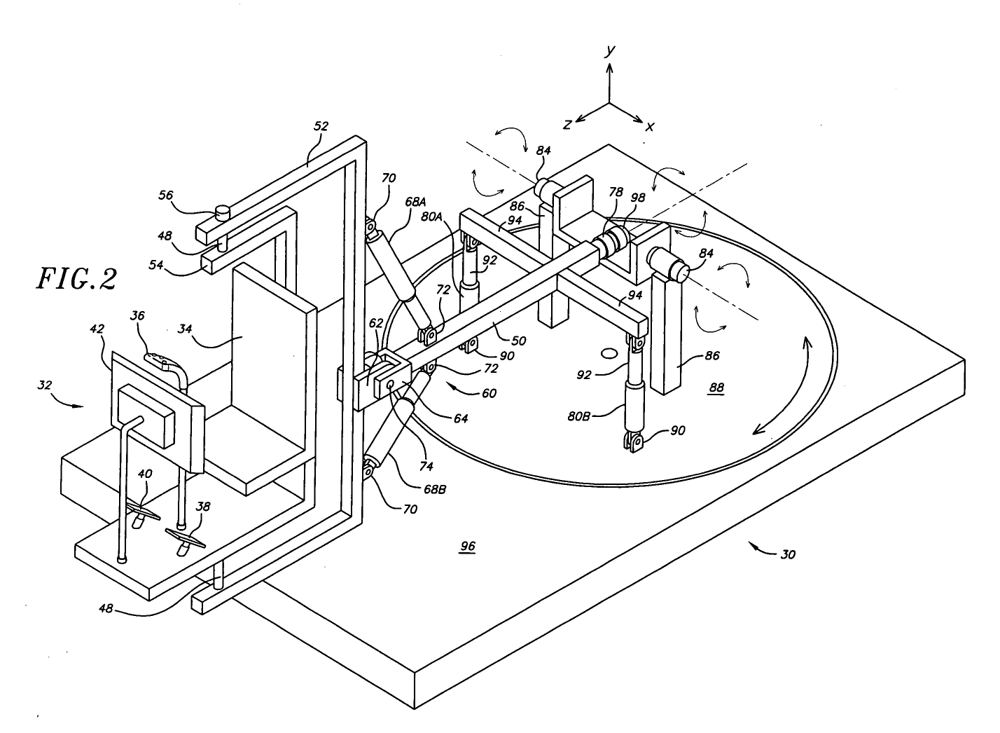

Turning now to FIG. 2, there are shown a diagrammatic front right isometric view showing an exemplary simulator of the invention. The vehicle simulator 30 includes a vehicle simulator operator environment 32 which includes a seat 34 with various operator controls, such as a joystick 36, foot peddles 38 and 40 and a control panel 42. As will be explained below, other operator environments can be provided. The operator environment 32 is connected to a boom 50 via an operator environment carriage 52. The operator environment 32 includes a cabin frame 54 which is attached to the operator environment carriage 52 via a pivot 48. In turn, the cabin frame 54 and the operator environment 32 can be rotated relative to the operator environment carriage 52 via yaw adjustor 56, which can, for example, comprise a motor. This will effect movement of the operator environment on the “Y” axis. The operator environment carriage 52 can be pivotally moved relative to the axis of the boom 50 by incorporating a clevis joint 60 between the operator environment carriage 52 and the boom 50. For example, a tang 62 can extend from the operator environment carriage 52 and a clevis 64 can be attached to the boom 50. In order to affect incline control of the operator environment and the operator environment carriage 52 relative to the boom 50, one or more incline controllers 68A, 68B may span between the clevis 64 and the operator environment carriage 52. For example, the incline controllers 68A and 68B can comprise cylinders (such as pneumatic, hydraulic or electric cylinders) which are pivotally connected at one end 70 to the operator environment carriage and at their other ends 72 to the clevis 64. The tang 62 is connected to the clevis by a pivot 74. Other mechanisms can be used instead, if desired. The pivot 48 between the cabin frame 54 and the operator environment carriage 52, along with its yaw adjuster (e.g., a motor 56) will affect a rotating movement along the pivot 48, which is generally along a Y axis when in an upright position. Again, the movement of the operator environment 32 relative to the incline adjuster established by the clevis joint 60 will affect movement of the operator environment along an axis of rotation of the Z axis which passes through a pivot 74 of the clevis joint 60. The operator environment 32 will also be rotatable along the X axis which runs through the longitudinal axis of the boom 50. The boom 50 passes through a boom retainer 78 and is turned relative thereto by, for example, articulating mechanisms having drive pistons 80A and 80B. The boom retainer 78 can comprise retainers which permit the boom 50 to be rotated along the X axis relative to a swing 82. The boom 50 can have a generally cylindrical end 98 that is rotatably retained by the boom retainer 78. The swing 82 has pivot ends 84 which lie on a z axis, and pivotally engage with posts 86 that extend upwardly from a platform 88. The pistons 80 are pivotally connected at lower ends 90 to the platform 88, and have upper ends 92 which are movably connected (e.g., with universal joints, etc.) to spars 94 that extend laterally outwardly from the boom 50 along the Z-axis. The upper and lower ends 90 and 92, respectively, of the pistons are pivotally attached to the platform 88 and to the ends of the spars 94 so that the ends of the spars 94 can trace a curved pathway when moved up and down. When the drive pistons 80A and 80B are both equally activated and extended by the same distance, the end of the boom 50 closer to the operator environment 32 will be raised up and the boom 50 will swing up on the swing 82. When the pistons 80A and 80B are both equally activated and are retracted by the same distance, the end of the boom 50 closer to the operator environment 32 will be lower. When the pistons 80A and 80B are moved differentially, e.g., piston 80A is moved down and piston 80B is moved up, this will rotate the operator environment 32 clockwise. Furthermore, if drive piston 80A is moved up and drive piston 80B is moved down by the same distance, this will rotate the boom 50 without otherwise raising or dropping the boom 50 or the user environment 32. Thus, this simple arrangement of two drive pistons 80A and 80B will function for both raising and lowering the boom 50 and the user environment 32 (providing translational motion along the Z-axis), and can also be used to rotate the boom and the user environment (providing rotational movement along the X-axis.) In order to provide for an optional swaying movement (rotational movement along the Y-axis to provide for movement in the XZ plane) of the operator environment 32 and the boom 50, the pistons 80A and 80B are optionally mounted to the platform 88, as are the posts 86, with the platform 88 being rotatable relative to a base portion 96. Rotational motion of the platform 88 relative to the base portion 96 can be achieved by a motor (not shown) connected to the platform 88 to the base 96.

Accordingly, the operator environment 32 can rotate on its X-axis (along the longitudinal axis of the boom 50), along the Y-axis (along the pivots 48), and along the Z-axis (along the clevis pivot 74). Translational motions of the operator environment 32 can also be established by the vehicle simulator 30. The boom. 50 can move up and down by tilting along the pivots 84 that run along the Z-axis and can sway by moving the platform 88 on its axis of rotation along the Y-axis relative to the base portion 96. If desired, the operator environment 32 can also be movable along the X-axis relative to the base portion 96. This can be achieved, for example, by incorporating a telescoping feature in the boom 50 (not shown) or providing for longitudinal movement of the platform 88 relative to the base portion 96. Thus, this embodiment of the vehicle simulator of the invention can be provided with between three and six degrees of freedom of motion.

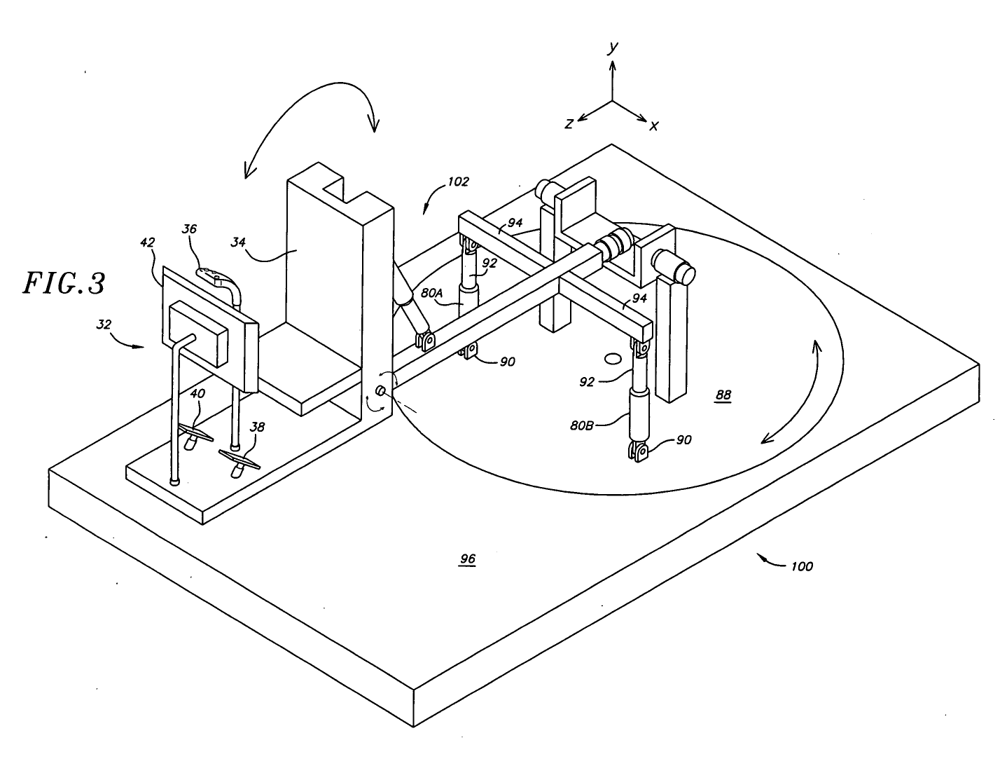

If a lower cost and/or simpler vehicle simulator having fewer degrees of motion is required, a vehicle simulator 100, such as that shown in FIG. 3, which is similar to the vehicle simulator 30 shown in FIG. 2, but lacks the Y-axis of rotation of the operator environment 32 and also lacks the ability to sway the operator environment 32 from side-to-side on the Y-axis (no lateral movement of the operator environment 32 along the Z-axis), can be used. In the vehicle simulator 100, the operator environment 32 is directly and hingeably attached along a Z axis to a boom 50, and a drive cylinder 102, extending between the boom 50 and the operator environment 32, is used to tilt the operator environment 32 relative to the boom 50. The boom 50 (and thus operator environment 32) is raised, lowered, and twisted by the drive cylinders 80A and 80B which connect to the spars 94 connected to the boom 50, in the same manner as described in connection with the first embodiment of the vehicle simulator of FIG. 2. Also, if a swaying (translational movement) of the operator environment 32 is not required, rather than having a rotating platform that carries the boom and rotates relative to the base portion 96, the posts 86 and drive pistons 80A and 80B can be mounted directly to the base portion 96.

Thus, with this embodiment of the vehicle simulator 100, the operator environment 32 can rotate on its X-axis (along the longitudinal axis of the boom 50) and along the Z-axis (along the clevis pivot 74). Translational motion(s) of the operator environment 32 can also be established by the vehicle simulator 100. The boom 50 can move up and down by tilting along the pivots 84 that run along the Z-axis and can optionally sway by rotating the platform 88 on its axis of rotation along the Y-axis relative to the base portion 96. If desired, the operator environment 32 can also be movable along the X-axis relative to the base portion 96. This can be achieved, for example, by incorporating a telescoping feature in the boom 50 (not shown). Thus, this embodiment of the vehicle simulator of the invention can provide three degrees of freedom of motion.

The vehicle simulators 30 and 100 of the invention can provide from three to six degrees of freedom of motion, namely, up to three degrees of rotational freedom of motion and up to three degrees of translational freedom of motion. These degrees of motion can be made with greater mechanical simplicity and much simpler software design since the geometry of the inventive design is much simpler as calculations of movement are made around a single axis of movement, whereas with prior motion basis, there is a complex relationship of the plurality of cylinders, i.e., six cylinders that must work in coordination in order to move the floating platform relative to a stationary base.

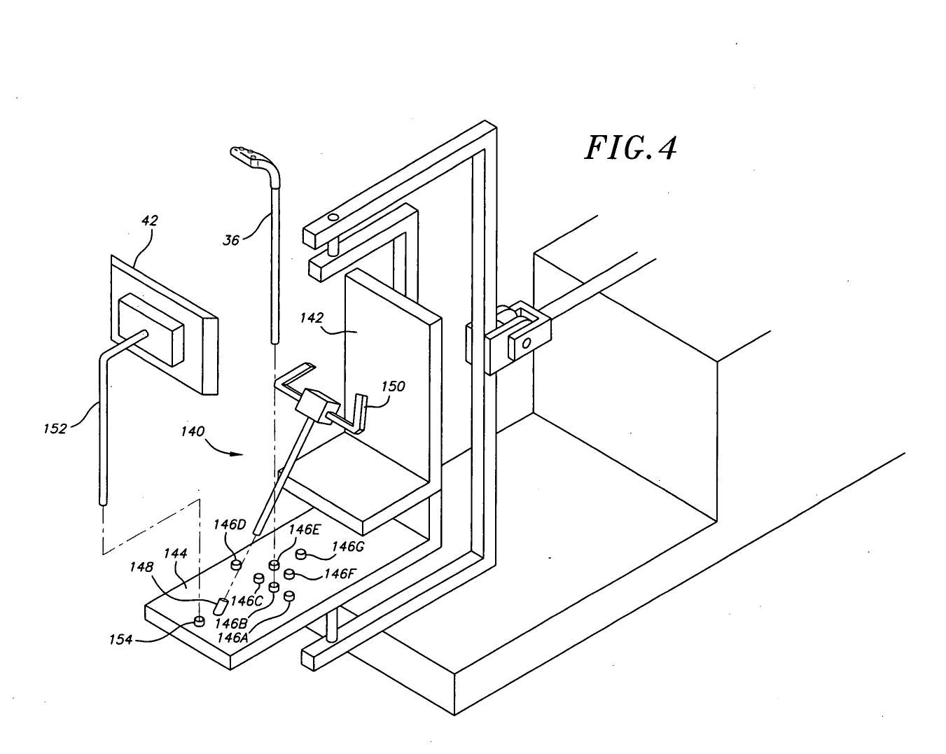

FIG. 4 is a front isometric diagrammatic view of an exemplary operator environment 140. It includes an occupant seat 142 and an occupant floor surface 144. Placed on the floor surface 144 are a plurality of ports, e.g., 146a through 146g and port 148. These ports are adapted to receive various control inputs such as the pedals 38 and 40 (as shown on FIG. 3), a joy stick 36, an airplane type steering wheel assembly 150 and other control inputs which are not shown, but which will depend on the vehicle being simulated. The number, pattern, spacing and type of ports 146a through 146g can be placed in the appropriate locations to receive input devices as required to simulate the desired vehicle operating environment. The individual ports 146a through 146g can include electrical and electronic connections, electromechanical motion sensing and driving mechanisms, stress sensors and other drives and sensors which simulate the controls of the vehicle being simulated. For example, the joystick port 146b will include a motorized module to provide the appropriate resistance that would be experienced by a pilot when operating the joystick. The same would apply to the airplane steering wheels control 150 and its port 148. Accordingly, the operating environment 140 can remain in place, and depending on what vehicle is to be simulated, different control devices can be inserted into the various ports. A control panel 42 on a control panel shaft 152 can be placed in a port 154 and by selecting the desired vehicle to be simulated, the control panel can instruct the user which ports to use and what controls to insert in which port, if desired. Hardware and software communication will be established between the ports and the controllers, and will be communicated to the various control devices so that appropriate movement of the operator environment is established by the user operating the simulated vehicle. For example, in the case of the joystick, by pushing forward on the joystick, this will be communicated via port 146b and cause the operator environment to be inclined downwardly. As noted above, since the operator environment will move on distinct axis of rotation and translation, the programming would be much simpler than with prior art devices. The ability to customize the operator environment can be included in the software that directs the motion control cylinders and motors. One or more computers will be used to establish communication between the operator controls in the vehicle operator environment and the motion actuating devices and mechanisms that actually are responsible for the six degrees of motion. These computer(s) will translate movement and/or other actuating of the operator controls in the vehicle operator environment to the motion actuating devices and mechanisms that actually are responsible for the six degrees of motion. Moreover, theses computer(s) can be programmed to establish the desired responses.

Although preferred embodiments of the present invention have been described, it should not be construed to limit the scope of the invention. In addition, those skilled in the art will understand that various modifications may be made to the described embodiments. Moreover, to those skilled in the various arts, the invention itself herein will suggest solutions to other tasks and adaptations for other applications. It is therefore desired that the present embodiments be considered in all respects as illustrated and not restrictive.

I, claim:

1. A vehicle simulator, comprising:
a vehicle simulator operator environment;
a vehicle simulator base;
a boom connecting the vehicle simulator operator environment to the vehicle simulator base;
at least one articulating mechanism for rotating the vehicle simulator operator environment along at least one axis of rotational motion to provide for a tilting motion of the vehicle simulator operator environment along a Z-axis of rotation; and
an articulating mechanism for moving the vehicle simulator operator environment along at least an X-axis of rotational motion along the boom and a Y-axis of translational motion with the boom relative to the vehicle simulator base.

2. The vehicle simulator of claim 1, wherein the vehicle simulator operator environment comprises a cabin frame which is pivotally connected along a Y-axis to an operator environment carriage to provide for rotational movement of the vehicle simulator operator environment along the Y-axis, which operator environment carriage is pivotally connected to the boom to permit rotation along the Z-axis relative to the boom to establish a tilting movement of the vehicle simulator operator environment relative to the boom, and wherein the boom is adapted to rotate along an X-axis relative to the vehicle simulator base to establish a turning movement of the vehicle simulator operator environment relative to the vehicle simulator base.

3. The vehicle simulator of claim 1, wherein the vehicle simulator base comprises a platform which carries the boom, which platform is rotatable relative to a base portion to provide for translational motion of the boom and vehicle simulator operator environment along the Z-axis.

4. The vehicle simulator of claim 1, wherein the boom has protrusion extending laterally therefrom and the articulating mechanism comprises a pair of drive cylinders which are attached between ends of the protrusions and the vehicle simulator base and a swing to which an end of the boom attaches.

5. The vehicle simulator of claim 4, the boom is rotatably attached to the swing to permit axial movement of the boom relative to the swing, and wherein the swing is adapted so that the boom can be raised and lowered and rotated.

6. The vehicle simulator of claim 1, wherein the vehicle simulator operator environment comprises a plurality of ports that are adapted to receive a plurality simulator control devices that correspond to a plurality of different vehicles to be simulated.

7. The vehicle simulator of claim 6, wherein the plurality of ports comprises at least one port that includes at least one of electrical connections and mechanical connections that communicate that a simulator control device has been engaged therewith, wherein selection of a set of desired simulator control devices will correspond to a plurality of different vehicles to be simulated.

8. The vehicle simulator of claim 6, wherein at least one port includes a mechanism that provides an appropriate degree of at least one of resistance and movement of the simulator control device engaged therewith.

9. The vehicle simulator of claim 6, further comprising a computer to establish communication between the simulator operator controls in the vehicle simulator operator environment and the motion actuating devices and mechanisms that are responsible for moving the vehicle simulator operator environment and boom.
